(19) United States
(12) Patent Application Publication
(10) Pub. No.: US 2004/0110659 A1
(43) Pub. Date: Jun. 10, 2004

(54) Alkyl and/or alkenyl glycerol carbamates

(76) Inventors: David Herault, Bourron-Marlotte (FR); Markus Wunderlich, Monheim (DE); Dirk Mampe, Duesseldorf (DE); Swantje Eckert, Monheim (DE)

Correspondence Address: COGNIS CORPORATION, PATENT DEPARTMENT, 300 BROOKSIDE AVENUE, AMBLER, PA, 19002, US

(21) Appl. No.: 10/474,578

(22) PCT Filed: Apr. 3, 2002
(86) PCT No.: PCT/EP02/03669

(30) Foreign Application Priority Data
Apr. 11, 2001 (DE) 101 18 109.4

(51) Int. Cl. C11D 1/00

(52) U.S. Cl. 510/499

(57) ABSTRACT

Alkyl and/or alkenyl glycerol carbamate prepared by reacting a carbonate selected from the group consisting of glycerol carbonate, diglycerol carbonate, polyglycerol carbonate and mixtures thereof, with an amine of the general formula (I):

HNR¹R² (I)

wherein R¹ represents a hydrogen atom or a hydrocarbon group selected from the group consisting of alkyl groups and alkenyl groups having from 1 to 22 carbon atoms and R² represents a hydrocarbon group selected from the group consisting of alkyl groups and alkenyl groups having from 4 to 22 carbon atoms, and cyclic alkyl groups having 5 or 6 carbon atoms, are described along with methods for their use as thickeners in surface-active preparations.

### FIELD OF THE INVENTION

This invention relates to alkyl and/or alkenyl glycerol carbamates which can be obtained by reaction of glycerol, diglycerol and/or polyglycerol carbonate with primary and/or secondary amines, to a process for their production and to their use as thickeners.

### PRIOR ART

Surface-active preparations such as, for example, lacquers, paints, dishwashing detergents, laundry detergents and cleaners and also cosmetic preparations often have an insufficiently low viscosity. It is immediately clear that a preparation with the flow behavior of water is very difficult to dose so that the user is in danger of always using more than is required. In order to counter this problem, thickeners are added to such preparations. These thickeners are often synthetic polymeric compounds such as, for example, poly(meth)acrylates, polyvinyl compounds, polycarboxylates; modified natural materials such as, for example, carboxymethyl celluloses and cellulose ethers; or even natural products such as, for example, agar agar, carrageen, alginates, pectins; but also polysilicic acids or clay minerals. There is a still a demand on the market for new thickeners which, besides their thickening effect, have other positive properties, such as ready biodegradability for example, and which can be inexpensively and simply produced.

Accordingly, the problem addressed by the present invention was to provide substances which would reliably thicken a broad range of surface-active preparations and which, at the same time, would be readily biodegradable and simple and relatively inexpensive to produce. In addition, these compounds would also be able to thicken systems that are difficult to thicken, such as microemulsions.

### DESCRIPTION OF THE INVENTION

The present invention relates to alkyl and/or alkenyl glycerol carbamates which are obtainable by reaction of glycerol, diglycerol and/or polyglycerol carbonate with a primary and/or secondary amine corresponding to formula (I):

HNR¹R² (I)

in which R¹ is H or a linear and/or branched alkyl and/or alkenyl group containing 1 to 22 carbon atoms and R² is a linear and/or branched alkyl and/or alkenyl group containing 4 to 22 carbon atoms or a cyclic alkyl group containing 5 or 6 carbon atoms.

The present invention also relates to a process for the production of alkyl and/or alkenyl glycerol carbamates in which glycerol, diglycerol and/or polyglycerol carbonate is/are reacted with a primary and/or secondary amine corresponding to formula (I):

HNR¹R² (I)

in which R¹ is H or a linear and/or branched alkyl and/or alkenyl group containing 1 to 22 carbon atoms and R² is a linear and/or branched alkyl and/or alkenyl group containing 4 to 22 carbon atoms or a cyclic alkyl group containing 5 or 6 carbon atoms.

It has surprisingly been found that alkyl and/or alkenyl glycerol carbamates are suitable as thickeners for a broad range of surface-active preparations and that the thickening effect, for example in cosmetic and/or pharmaceutical preparations, is obtained by addition of only small quantities of the carbamates. At the same time, they are readily biodegradable and can be produced by simple reaction of glycerol, diglycerol and/or polyglycerol carbonate with primary or secondary amines. In addition, systems that are difficult to thicken, such as microemulsions, can be reliably thickened by addition of alkyl and/or alkenyl glycerol carbamates.

Alkyl and/or Alkenyl Glycerol Carbamates

According to the invention, the alkyl and/or alkenyl glycerol carbamates used are obtained by reaction of glycerol, diglycerol and/or polyglycerol carbonate, preferably glycerol and/or diglycerol carbonate and, more particularly, glycerol carbonate, with a primary and/or secondary amine corresponding to formula (I):

HNR¹R² (I)

in which R¹ is H or a linear and/or branched alkyl and/or alkenyl group containing 1 to 22, preferably 6 to 18 and more particularly 8 to 16 carbon atoms and R² is a linear and/or branched alkyl and/or alkenyl group containing 4 to 22, preferably 6 to 18 and more particularly 8 to 16 carbon atoms or a cyclic alkyl group containing 5 or 6 and preferably 6 carbon atoms, more particularly a linear and/or branched alkyl and/or alkenyl group containing 1 to 22, preferably 6 to 18 and more particularly 8 to 16 carbon atoms.

Glycerol carbonate is:

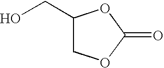

Diglycerol carbonate is a mixture of:

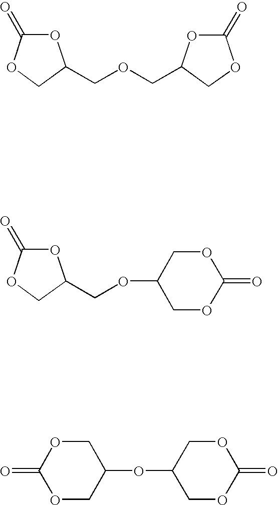

The compounds used in the reaction with polyglycerol carbonates have a molecular weight of preferably 200 to 1,000, more preferably 300 to 800 and most preferably 400 to 700 g/mol and contain preferably 2 to 9.2, more preferably 3 to 8 and most preferably 4 to 7 mmol CO₂ per g polyglycerol carbonate. The latter characteristic is a coulometric quantitative determination of organic carbonates by modification to DIN 18 129. A sample of the carbonate is weighed in, hydrolyzed for 1 h at 50° C. with a 1.4 M NaOH 15:1 methanol/water solution and the quantity of CO₂ released by acidification is determined using a carbon dioxide analyzer (UIC Model CM 140 or an equivalent instrument).

One particular embodiment of the present invention is characterized by the use of alkyl and/or alkenyl glycerol carbamates which are obtained by reaction of glycerol and/or diglycerol carbonate with a primary and/or secondary amine corresponding to formula (I), in which R¹ is H or a linear and/or branched alkyl and/or alkenyl group containing 1 to 22, preferably 6 to 18 and more particularly 8 to 16 carbon atoms and R² is a linear and/or branched alkyl and/or alkenyl group containing 4 to 22, 1 to 22, preferably 6 to 18 and more particularly 8 to 16 carbon atoms or a cyclic alkyl group containing 5 or 6 carbon atoms.

Another preferred embodiment of the present invention is characterized by the use of alkyl and/or alkenyl glycerol carbamates which are obtained by reaction of glycerol and/or diglycerol carbonate with a primary and/or secondary amine corresponding to formula (I), in which R¹ is H and R² is a linear and/or branched alkyl and/or alkenyl group containing 4 to 22 carbon atoms or a cyclic alkyl group containing 5 or 6 carbon atoms and preferably a linear and/or branched alkyl and/or alkenyl group containing 6 to 18 and more particularly 8 to 16 carbon atoms.

A particular embodiment of the invention is characterized by the use of alkyl and/or alkenyl glycerol carbamates which are obtained by reaction of glycerol carbonate with a primary and/or secondary amine such as, preferably, butylamine, pentylamine, octylamine, decylamine, dodecyl-amine, tetradecylamine, hexadecylamine, octadecylamine, behenylamine, oleylamine (for example Genamin OL 100 D from Clariant), stearylamine (for example Armeen 18 D from Akzo Nobel), cocoylamine (for example Genamin CC 100 from Clariant), 2-ethylhexylamine, isotridecylamine, 2-butyloctylamine, 2-hexyldecylamine, 2-octyldodeylamine, cyclohexylamine, tert. octylamine (for example Primene TOA from Rohm & Haas), tert. dodecyl/tetradecylamine (for example Primene 81-R from Rohm & Haas), tert. octadecylamine (for example Primene JM-T from Rohm & Haas), dibutylamine, dicocoylamine (for example Armeen 2C from Akzo Nobel), di-2-ethylhexylamine, N-methylcyclohexylamine, and, more particularly, octylamine, octadecylamine, oleylamine, cocoylamine, isotridecylamine.

Suitable alkyl and/or alkenyl glycerol carbamates are, for example, the following compounds (only one regioisomer is shown by way of example):

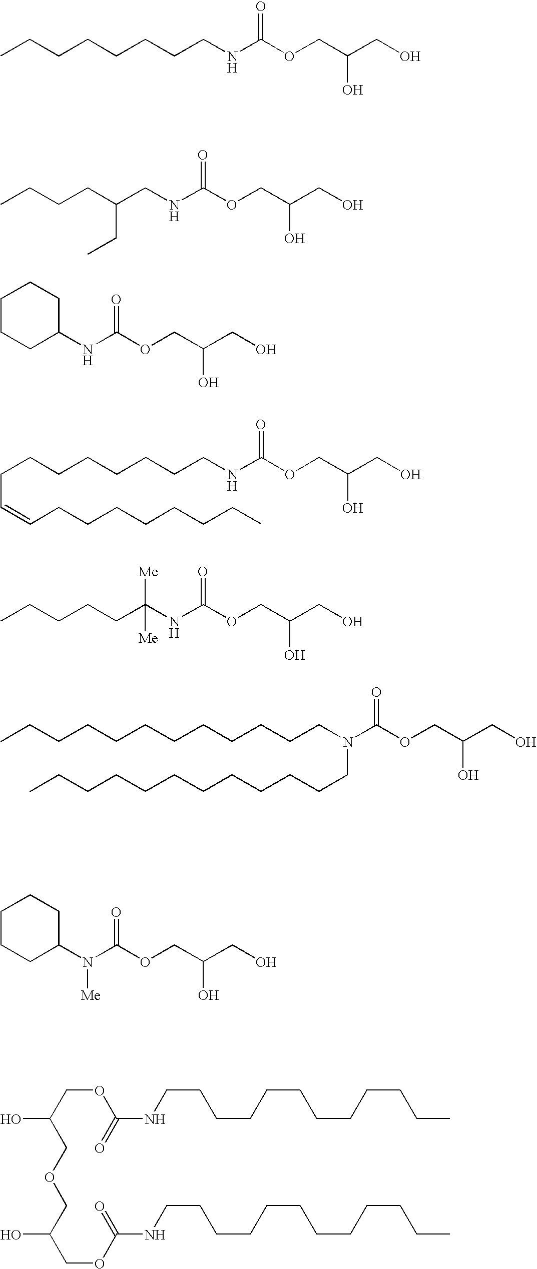

The alkyl and/or alkenyl glycerol carbamates according to the invention are used in surface-active preparations, preferably in laundry detergents, dishwashing detergents and cleaners, and in cosmetic and/or pharmaceutical preparations, more particularly in cosmetic and/or 10 pharmaceutical preparations, in quantities of 0.01 to 20, preferably 1 to 10 and more particularly 2.5 to 5.5% by weight, based on the preparations.

Production of Alkyl and/or Alkenyl Glycerol Carbamates

The alkyl and/or alkenyl glycerol carbamates according to the invention are obtained by reaction of glycerol, diglycerol and/or polyglycerol carbonate with a primary and/or secondary amine corresponding to formula (I).

Glycerol, diglycerol and/or polyglycerol carbonate can be produced by methods known from the prior art as described, for example, in patent applications JP 06329663, U.S. Pat. No. 5,091,543, EP 0582201 A1 or EP 0955298 A1. The starting compound used for the synthesis of polyglycerol carbonates is polyglycerol of which the production is described in patent application DE 4029232 A1. Other processes for the production of polyglycerol are disclosed in patent application DE 4117033 A1 or U.S. Pat. No. 5,430,866.

Glycerol carbonate is obtained by base-catalyzed (for example 1 mol-% NaOMe) transesterification of 1 mol glycerol with 1,6 mol dimethyl carbonate at ca. 70 to 80° C. and removal of the methanol formed and excess DMC by distillation as described in U.S. Pat. No. 5,091,543.

Diglycerol carbonate is obtained by reaction of 1 mol diglycerol (TCI America Catalog, Number T01 19, 80% purity) with 3,2 mol dimethyl carbonate as described above.

Polyglycerol carbonate is preferably obtained by reaction of polyglycerol-4 (Solvay S. A.) with an excess of dimethyl carbonate as described above.

To produce the alkyl and/or alkenyl glycerol carbamates, an amine of formula (I) is placed in a reaction vessel and glycerol carbonate, di- and/or polyglycerol carbonate is/are added dropwise with stirring over a period of 1 to 24 and preferably 2 to 10 hours in a molar ratio of 0.5:1 to 1:2, preferably 0.75:1 to 1:1.5 and more particularly 1:1, the reaction temperature being kept between room temperature and 120° C. and preferably between 70 and 90° C. A particular embodiment of the invention —in accordance with International patent application WO 98/50345—also comprises a reaction in the presence of catalysts, such as preferably bases, of which the conjugated acid has a pKs value of 11 or more.

The alkyl and/or alkenyl glycerol carbamates according to the invention may be used as such without any further working up. Alternatively, to remove the quantities of glycerol, diglycerol and/or polyglycerol carbonate still present after the end of the reaction, the crude product may be taken up in a suitable solvent, preferably dichloromethane or toluene, and then extracted with a weakly acidic hydrochloric acid solution. The solvent is then removed and the end product is dried with a drying agent. Other purification steps, such as removal of the residual educts by distillation or chromatography, are also possible.

The reaction of glycerol carbonate with a primary and/or secondary amine is illustrated purely by way of example in the following reaction equation. Two regioisomers are formed:

Commercial Applications

The glycerol carbamates according to the invention may be used in surface-active preparations. Surface-active preparations in the context of the invention are preferably laundry detergents, dishwashing detergents and household cleaners; cosmetic and/or pharmaceutical preparations; drilling fluids for oil fields; paper, leather, textile, adhesive, pesticide and agricultural preparations and, more particularly, laundry detergents, dishwashing detergents and household cleaners and cosmetic and/or pharmaceutical preparations. Besides the carbamates according to the invention, these surface-active preparations may contain other known ingredients typical of the particular application in the usual concentrations. The total percentage content of the typical ingredients may be in the range from 1 to 80, preferably 5 to 50 and more particularly 7 to 10% by weight, based on the preparation.

Preferred cosmetic and/or pharmaceutical preparations are hair shampoos, hair lotions, foam baths, shower baths, creams, gels, lotions, alcoholic and aqueous/alcoholic solutions and emulsions which may contain pearlizing waxes, superfatting agents, stabilizers, silicone compounds, fats, waxes, lecithins, phospholipids, antioxidants, deodorants, antiperspirants, antidandruff agents, swelling agents, tyrosine inhibitors, hydrotropes, solubilizers, preservatives, perfume oils, dyes, other surfactants and the like as further auxiliaries and additives. The total percentage content of the auxiliaries and additives may be in the range from 1 to 80, preferably 5 to 50 and more particularly 7 to 10% by weight, based on the preparation. The preparations may be produced by standard cold or hot emulsification or by the PIT process.

The compounds according to the invention may advantageously be used as thickeners in surface-active preparations. Accordingly, the present invention also relates to the use of the alkyl and/or alkenyl glycerol carbamates according to the invention as thickeners in surface-active preparations, preferably in laundry detergents, dishwashing detergents and household cleaners, and in cosmetic and/or pharmaceutical preparations, more particularly in cosmetic and/or pharmaceutical preparations.

Laundry detergents, dishwashing detergents and household cleaners and cosmetic and/or pharmaceutical preparations, more particularly cosmetic and/or pharmaceutical preparations, containing the carbamates according to the invention, preferably as thickeners, in quantities of 0.01 to 10, preferably 1 to 8 and more particularly 2.5 to 5.5% by weight, based on the preparations, preferably have Brookfield viscosities in the range from 1,000 to 300,000, more preferably in the range from 2,000 to 100,000 and most preferably in the range from 6,000 to 25,000 cps (23° C., 10 r.p.m., spindle 4).

In one particular embodiment of the invention, the compounds according to the invention are used as thickeners in the above-mentioned concentrations in cosmetic and/or pharmaceutical microemulsions (see Falbe, J., Repitz, M., Rbmpp Lexikon Chemie, 10th Edition, 1996-1999, Georg Thieme Verlag, ISBN 3131078308).

Typical cosmetic and/or pharmaceutical cleaning preparations preferably have the following composition:

(a) 0.01 to 10, preferably 1 to 8 and more particularly 2.5 to 5.5% by weight of the alkyl and/or alkenyl glycerol carbamates according to the invention and

(b) 3 to 30, preferably 5 to 20 and more particularly 10 to 15% by weight surfactants,

with the proviso that the quantities shown add up to 100% by weight with water and optionally other auxiliaries and additives.

Typical cosmetic and/or pharmaceutical emulsions preferably have the following composition:

(a) 0.01 to 10, preferably 1 to 8 and more particularly 2.5 to 5.5% by weight alkyl and/or alkenyl glycerol carbamates,

(b) 3 to 30, preferably 5 to 20 and more particularly 10 to 15% by weight oil components and

(c) 1 to 30, preferably 3 to 20 and more particularly 5 to 10% by weight surfactants,

with the proviso that the quantities shown add up to 100% by weight with water and optionally other auxiliaries and additives.

### EXAMPLES

The following Examples are intended to illustrate the invention without limiting it in any way.

The substances according to the invention were tested in four different basic formulations which had the following composition:

TABLE 1
Cleaning composition - basic formulation (1)

| Substance (% by weight | | | | |
|---|---|---|---|---|
| active substance) | Quantities in g | | | |
| Plantacare ® 2000 (Cognis) | 160 | 320 | 480 | 640 |
| C8-C16 alkyl glucoside (53) | | | | |
| Texapon NSO (Cognis) | 130 | 260 | 390 | 520 |
| Sodium lauryl ether + 2EO sulfate (27) | | | | |
| Lamepon S (Cognis) | 90 | 180 | 270 | 360 |
| Potassium cocohydrolyzed animal | | | | |
| protein (32) | | | | |
| Euxyl K 400 (Schuelke & Mayr) | 1 | 2 | 3 | 4 |
| Methyl dibromoglutaronitrile (80) and | | | | |
| phenoxyethanol (20) | | | | |
| Water | 519 | 1038 | 1557 | 2076 |
| Total quantity | 900 | 1800 | 2700 | 3600 |

weigh in all substances
stir homogeneously with a blade stirrer at ca. 300 r.p.m.
adjust a pH of 5.5 with 50% by weight citric acid

TABLE 2
Cleaning composition - basic formulation (2)

| Substance (% by weight active substance) | Quantities in g | | | |
|---|---|---|---|---|
| Texapon NSO (Cognis) | 400 | 800 | 1200 | 1600 |
| Sodium lauryl ether + 2EO sulfate (27) | | | | |
| Dehyton ® K (Cognis) | 35 | 70 | 105 | 140 |
| Coco Amido Propyl Betaine (30) | | | | |
| Plantacare ® 1200 UP (Cognis) | 80 | 160 | 240 | 320 |
| C8-C16 alkyl glucoside (52) | | | | |
| Lamesoft PW 45 (Cognis) | 100 | 200 | 300 | 400 |
| Cetylpalmitate Beheneth-10/hydrogenated | | | | |
| castor oil/glycerol stearate (45) | | | | |
| Euxyl K 400 (Schuelke & Mayr) | 1 | 2 | 3 | 4 |
| Methyl dibromoglutaronitrile (80) and | | | | |
| phenoxyethanol (20) | | | | |
| Water | 284 | 568 | 852 | 1136 |
| Total quantity | 900 | 1800 | 2700 | 3600 |

weigh in all substances except Lamesoft PW 45
stir homogeneously with a blade stirrer at ca. 300 r.p.m.
add Lamesoft and re-stir
adjust a pH of 5.5 with 50% by weight citric acid

TABLE 3
Microemulsion - basic formulation (3)

| Substance (% by weight active | | | | |
|---|---|---|---|---|
| substance) | Quantities in g | | | |
| Texapon NSO (Cognis) | 570 | 1140 | 1710 | 2280 |
| Sodium lauryl ether + 2EO sulfate (27) | | | | |
| Lamesoft PO 65 (Cognis) | 200 | 400 | 600 | 360 |
| Cocoglycoside/glyceryl oleate (67) | | | | |
| Cetiol PGL (Cognis) | 44 | 88 | 132 | 176 |
| Hexyldecanol/hexyldecyl laurate (99) | | | | |
| 1,6-Hexane diol (99) | 80 | 160 | 240 | 320 |
| Euxyl K 400 (Schuelke & Mayr) | 1 | 2 | 3 | 4 |
| Methyl dibromoglutaronitrile (80) and | | | | |
| phenoxyethanol (20) | | | | |
| Water | 5 | 10 | 15 | 20 |
| Total quantity | 900 | 1800 | 2700 | 3600 |

mix Texapon NSO and Lamesoft PO 65 homogeneously with a blade stirrer
stir in Cetiol PGL
add 1,6-hexanediol with stirring and dissolve
finally stir in water and Euxyl K 400
adjust a pH of 5.5 with 50% by weight NaOH

TABLE 4
Emulsion - basic formulation (4)

| Substance (% by weight active | | | | |
|---|---|---|---|---|
| substance) | Quantities in g | | | |
| Texapon NSO (Cognis) | 320 | 640 | 960 | 1280 |
| Sodium lauryl ether + 2EO sulfate (27) | | | | |
| Dehyton ® K (Cognis) | 90 | 180 | 270 | 360 |
| Coco Amido Propyl Betaine (30) | | | | |
| Euxyl K 400 (Schuelke & Mayr) | 1 | 2 | 3 | 4 |
| Methyl dibromoglutaronitrile (80) and | | | | |
| phenoxyethanol (20) | | | | |
| Water | 489 | 978 | 1467 | 1956 |
| Total quantity | 900 | 1800 | 2700 | 3600 |

weigh in all substances
stir homogeneously with a blade stirrer at ca. 300 r.p.m.
adjust a pH of 5.5 with 50% by weight NaOH

### Example 1

### Preparation of Octyl Glycerol Carbamate

132 g octylamine (1 mol, 98%, Fluka) were introduced into a reaction vessel and heated to 70-80° C. 119 g (1 mol) glycerol carbonate (90%) were then added dropwise over a period of 4 hours with mechanical 5 stirring. Following an after-reaction time of 1 hour at 80° C., the hydrophilic impurities were removed by taking up the crude product in 150 ml dichloromethane and extraction with 50 ml water and dilute hydrochloric acid solution. After drying with Na₂SO₄ and removal of the solvent, a solid regioisomer mixture of octyl glycerol carbamate was obtained in a yield of ca. 170 g (70%).

Examples 2 to 9 below were carried out in the same way as Example 1.

### Example 2

Oleyl Glycerol Garbamate from 1 mol Genamin OL 100 D (Clariant) and 1 mol Glycerol Carbonate

### Example 3

Cocoyl Glycerol Carbamate from 1 mol Genamin CC 100 (Clariant) and 1 mol Glycerol Carbonate

### Example 4

Tert. Octadecyl Glycerol Carbamate from 1 mol Primene JM-T (Rohm & Haas) and 1 mol Glycerol Carbonate

### Example 5

tert. C_{12/14} Alkyl Glycerol Carbamate from 1 mol Primene 81-R (Rohm & Haas) and 1 mol Glycerol Carbonate

### Example 6

Tert. Octyl Glycerol Carbamate from 1 mol Primene TOA (Rohm & Haas) and 1 mol Glycerol Carbonate

### Example 7

Dodecyl Glycerol Carbamate from 1 mol Dodecylamine and 1 mol Glycerol Carbonate

### Example 8

Stearyl Glycerol Carbamate from 1 mol Armeen 18D (Akzo Nobel) and 1 mol Glycerol Carbonate

### Example 9

Dodecyl Diglyceryl Carbamate from 2 mol Dodecylamine and 1 mol Diglycerol Carbonate.

Table 5 shows some Examples which contain 84.5 to 97% by weight of the basic formulations of Tables 1 to 4 and 3 to 5% by weight—based on the active substance content—of alkyl and/or alkenyl glycerol carbamates corresponding to Examples 1 to 9 as thickeners and optionally 0.5% by weight NaCl. The viscosities of preparations 1 to 4 in Table 5 were determined by the Brookfield method (Brookfield RVF viscosimeter, 23° C., spindle 4, 10 r.p.m., CPS).

TABLE 5
Thickened basic formulations 1 to 4, quantities in % by weight, based on active
substance content

| | % by | NaCl | | 1 | 2 | 3 | 4 |
|---|---|---|---|---|---|---|---|
| Thickener | wt. | % by wt. | pH | [mPas] | [mPas] | [mPas] | [mPas] |
| Octyl glycerol carbamate | 3 | | 5.5 | | 3200 | | 13200 |
| | 3 | 0.5 | 5.5 | | 15400 | | 14400 |
| Oleyl glycerol carbamate | 5 | | 5.5 | 3100 | 14000 | | 7600 |
| | 5 | 0.5 | 5.5 | 1100 | 9700 | | |
| Cocoyl glycerol | 3 | | 5.5 | | 3600 | | 9400 |
| carbamate | 3 | 0.5 | 5.5 | | 28000 | | 18600 |
| Cocoyl glycerol | 5 | | 5.5 | 1400 | 5200 | | 7800 |
| carbamate | 5 | 0.5 | 5.5 | | | | |
| t-Octadecyl glycerol | 5 | | 5.5 | | 2700 | 4000 | |
| carbamate | 5 | 0.5 | 5.5 | | 8600 | 16500 | |
| t-C_{12/14} alkyl glycerol | 3 | | 5.5 | | 6400 | | |
| carbamate | 3 | 9.5 | 5.5 | | 6100 | | |
| t-C_{12/14} alkyl glycerol | 5 | | 5.5 | | 6900 | | 1700 |
| carbamate | 5 | 0.5 | 5.5 | | | | |
| t-octyl glycerol carbamate | 5 | | 5.5 | | 3700 | | |
| | 5 | 0.5 | 5.5 | | 4300 | | |
| Dodecyl glycerol | 5 | | 5.5 | 1200 | | | |
| carbamate | 5 | 0.5 | 5.5 | 1000 | | | |
| Octadecyl glycerol | 5 | | 5.5 | | 1450 | | |
| carbamate | 5 | 0.5 | 5.5 | | 6600 | 1700 | |
| C₁₂ diglycerol carbamate | 3 | | 5.5 | | 1700 | | |
| | 3 | 0.5 | 5.5 | | 18300 | | |
| C₁₂ diglycerol carbamate | 5 | | 5.5 | | 6800 | | 2050 |
| | 5 | 0.5 | 5.5 | 1720 | | | 1900 |

1. Alkyl and/or alkenyl glycerol carbamates obtainable by reaction of glycerol, diglycerol and/or polyglycerol carbonate with a primary and/or secondary amine corresponding to formula (I):
HNR¹R² (I)
in which R¹ is h or a linear and/or branched alkyl and/or alkenyl group containing 1 to 22 carbon atoms and r² is a linear and/or branched alkyl and/or alkenyl group containing 4 to 22 carbon atoms or a cyclic alkyl group containing 5 or 6 carbon atoms:

2. Compounds as claimed in claim 1, characterized in that glycerol and/or diglycerol carbonate is/are reacted with a primary and/or secondary amine corresponding to formula (I), in which R¹ is H or a linear and/or branched alkyl and/or alkenyl group containing 1 to 22 carbon atoms and R² is a linear and/or branched alkyl and/or alkenyl group containing 4 to 22 carbon atoms or a cyclic alkyl group containing 5 or 6 carbon atoms.

3. Compounds as claimed in claims 1 and/or 2, characterized in that glycerol carbonate is reacted with a primary and/or secondary amine corresponding to formula (I), in which R¹ is H and R² is a linear and/or branched alkyl and/or alkenyl group containing 4 to 22 carbon atoms or a cyclic alkyl group containing 5 or 6 carbon atoms.

4. Compounds as claimed in at least one of claims 1 to 3, characterized in that glycerol carbonate is reacted with a primary and/or secondary amine corresponding to formula (I), in which R¹ is H and R² is a linear and/or branched alkyl and/or alkenyl group containing 6 to 18 carbon atoms.

5. Compounds as claimed in at least one of claims 1 to 4, characterized in that glycerol carbonate is reacted with amines selected from the group consisting of butylamine, pentylamine, octylamine, decylamine, dodecylamine, tetradecylamine, hexadecylamine, octadecylamine, behenylamine, oleylamine, stearylamine, cocoylamine, 2-ethylhexylamine, 2-butyloctylamine, 2-hexyldecylamine, 2-octyldodeylamine, isotridecylamine, cyclohexylamine, tert. octylamine, tert. dodecyl/tetradecylamine, tert. octadecylamine, dibutylamine, dicocoylamine, di-2-ethylhexylamine and N-methylcyclohexylamine.

6. Surface active preparations as claimed in at least one of claims 1 to 5, characterized in that they contain the compounds claimed in claim 1 in quantities of 0.01 to 20% by weight, based on the preparation.

7. Laundry detergents, dishwashing detergents and cleaners and cosmetic and/or pharmaceutical preparations as claimed in at least one of claims 1 to 5, characterized in that they contain the compounds claimed in claim 1 in quantities of 0.01 to 10, preferably 1 to 8 and more particularly 2.5 to 5.5% by weight, based on the preparation.

8. A process for the production of alkyl and/or alkenyl glycerol carbamates in which glycerol, diglycerol and/or polyglycerol carbonate is/are reacted with a primary and/or secondary amine corresponding to formula (I):
HNR¹R² (I)
in which R¹ is H or a linear and/or branched alkyl and/or alkenyl group containing 1 to 22 carbon atoms and R² is a linear and/or branched alkyl and/or alkenyl group containing 4 to 22 carbon atoms or a cyclic alkyl group containing 5 or 6 carbon atoms.

9. The use of the compounds claimed in claim 1 as thickeners in surface-active preparations.

10. The use claimed in claim 9 as thickeners in cosmetic and/or pharmaceutical preparations.
